(19) United States
(12) Patent Application Publication
(10) Pub. No.: US 2026/0340619 A1
(43) Pub. Date: Oct. 29, 2026

(54) Method and system for conducting a cashless transaction

(71) Applicant: Airwallet ApS, 5000 Odense C (DK)

(72) Inventor: Christian B. Mortensen, Odense (DK)

(21) Appl. No.: 19/193,187

(22) Filed: Apr. 29, 2025

(51) Int. Cl. G06Q 20/32; G06Q 30/0207; G06Q 30/0214

(52) U.S. Cl. CPC G06Q 20/326; G06Q 20/3226; G06Q 30/0209; G06Q 30/0214

(57) ABSTRACT

A method and system are shown for conducting a cashless transaction for purchase of at least one commercial service by a user from a machine. If the user does not already have a user profile, then the user creates a user profile and a user account using an application on a mobile device. The user then selects a machine at a certain location and further selects a service of that machine and afterwards initiates the payment by transmitting transaction information from the application to the management platform. The management platform conducts the payment and transmits updated transaction information back to the application. The management platform further transfers an amount equal to the selected services to the service provider. The management platform comprises various modules that enhances user engagement and rewards user loyalty, while simplifying transactions and reducing operational barriers.

### TECHNICAL FIELD

The present invention relates to a method of conducting a cashless transaction for purchase of at least one commercial service by a user from a machine having input means. The user has a mobile device in which an application is running, which is configured to communicate with a management platform for payment of services selected on the machine.

The present invention also relates to a system configured to execute the steps of the abovementioned method.

### BACKGROUND OF THE INVENTION

Industries that provide physical services typically reply on customers interacting with machines located various locations, wherein the customer is able to conduct onsite payments for a selected service of a selected machine. Service providers operating commercial services facilities, such as laundromats, have a plurality of service providing machines, such as dryers and/or washers, installed at different locations. Customers are then able to enter one of these locations and conduct payments for such services using a payment system. Universities, apartment buildings, large businesses, etc. may also have a plurality of service providing machines, such as dryers and/or washers, installed at a given location, where a commercial service provider manages and operates the machines of the laundromat on behalf of the client. Previously, a cash payment system was installed for each machine and the user was required to pay with coins or tokens.

In recent years, the development of digital payment systems has changed the way that businesses interact with their customers. Industries that rely on physical services, such as laundromats, still face unique challenges. These challenges stem from operational costs, technical complexities, and the unpredictability of expenses tied to modernizing their payment technologies. Furthermore, traditional cash-based systems, while simple, fall short in delivering the efficiency, convenience, and scalability demanded by today's consumers. The existing solutions available on the market are illustrated in FIG. 1.

Examples of such digital payment systems for commercial services or service facilities are disclosed in US 2024/0257093 A1 and U.S. Pat. No. 11,501,296 B2. Further examples of such methods and systems for digital payment of laundry services where the machines are identified by detection of beacon signals emitted from the machines are disclosed in US 2017/0082991 A1 and CA 3038549 A1. Further, CN 109811507 A and CN 108053574 A disclose a method and system for identifying a laundry machine by scanning a code on the machine.

Further, existing digital solutions often impose transaction fees, subscription costs, or upfront investments that deter adoption, particularly among cost-sensitive operators. Simultaneously, customers today seek seamless, affordable, and flexible payment experiences that align with their increasingly digital lifestyles.

Therefore, there is still a need for improving the payment systems of such commercial services and simplifying transactions between customers and service providers.

### OBJECT OF THE INVENTION

One object of the present invention is to overcome the abovementioned problems or at least provide an alternative solution.

One object of the present invention is to provide a system and method that promotes customer loyalty.

One object of the present invention is to provide a system and method that reduces operational costs and barriers.

### SUMMARY OF THE INVENTION

One object of the present invention is achieved by a method, according to claim 1, of conducting a cashless transaction for purchase of at least one commercial service by a user from a machine, the user having a mobile device with at least a processor, a memory, a display and a communications module, wherein an application is installed on the mobile device, the method comprising the steps of:
executing the application on the mobile device, wherein user interacts with the application via at least one graphic user interface of the application,
selecting, using the application, at least one machine of at least one service provider and further selecting at least one service of the at least one machine,
initiating, by the application, a payment of the selected services by transmitting transaction information to a management platform of a system provider, in which the user has created a user profile and a user account,
if the payment is completed, then transferring, by the management platform, an amount of payment equivalent to the selected service from the user's account to the service provider of that selected machine,
transmitting, by the management platform, updated transaction information back to the application on the mobile device, and
if the payment is completed, activating, by the user, the selected machine using input means on the machine.

This provides a method of payment for services from service providers using an improved digital payment process. This present method also provides a flexible and scalable solution that can be adapted to the demands of the customers, thereby enhancing user engagement and profitability, and thus promoting customer loyalty, compared to traditional payment methods.

The present method enables customers to create a user profile and set up an account at the management platform of the system provider, by simply downloading and installing an application on their mobile device. The user is thus able to set up a user profile, a user account and payment details. This application can be used to pay for services at service providers of different industries as well as service providers within the same industry. This simplifies transactions between the service provider and the customer and reduces costs for modernizing the payment technologies of cost-sensitive service providers.

The user uses the application to identify and select a particular machine at a certain location. The location of the user may be determined using the geographic location of the mobile device, triangulation of signals from the mobile device or by establishing a connection with a local wireless network (e.g. WIFI or short-range network). Alternatively, the user may manually, using the application, enter or transmit the location to the management platform via the mobile device. However, other positioning techniques may also be used. This allows the present system to determine the location of the user.

The user then interacts with a dedicated graphical user interface of the application to select a machine of a particular service provider at a particular location, e.g. the location of the mobile device. For example, a list of machines installed at that location may be transmitted to the mobile device from the management platform. The list may be displayed to the user via the graphical user interface, from which the user may select a particular machine.

Further, the user interacts with another dedicated graphical user interface of the application to select a service on the selected machine. For example, the management platform may transmit a list of services available on that machine to the mobile device, upon receiving information of the selected machine. The list may be displayed to the user via the graphical user interface, from which the user may select a particular service. Optionally, the management platform may further transmit to the mobile device updated status information for each machine, such as if a particular machine is vacant, booked or running. This allows the user to quickly get an overview of the machines and services available for selection.

The present system enables the user to continue interacting with the graphical user interfaces of the application to select further machines and/or further services at that location. This allows users to select multiple services on one or more machines, if desired.

Upon completing the selection process, the user proceeds to interact with a further dedicated graphical user interface of the application to initiate payment for the selected services. The selected services and total amount are accumulated in the management platform, or alternatively in the application, and displayed to the user in the graphical user interface. The user is then able to confirm payment by simply interacting with the graphical user interface, e.g. by swiping in the application.

Transaction information is subsequently transmitted from the mobile device to the management platform, e.g. via a secure data connection or by encrypting the transaction information. The management platform then completes the transaction process by deducting the total amount from the account associated with the user. Optionally, a confirmation of payment and/or updated status of the user account may be transmitted back to the mobile device and displayed to the user in the application.

The management platform subsequently transfers the total amount via a secure payment module to the service provider. Payment is thus made between the user and the system provider, which manages the digital payment process on behalf of the service providers. This simplifies the transaction process and reduces the overall transaction fees. Further, the service provider saves operational costs and time as the digital payment solution is managed by the system provider.

According to one embodiment, the method further comprises the steps of:
selecting, using the application, another machine of another service provider and further selecting a service of the other machine,
initiating, by the application, a payment of the selected further service by transmitting transaction information to the management platform,
if the payment is completed, then transferring, by the management platform, an amount of payment equivalent to the selected further service from the user's account to the other service provider of that other machine,
transmitting, by the management platform, updated transaction information back to the application on the mobile device, and
if the payment is completed, optionally activating, by the user, the other machine using input means on the other machine.

Unlike other known solutions, the present system can be used to conduct payments for services from multiple service providers. In the known solutions, the user must set up an account directly at the service provider, hence limiting the usage to that service provider. Hence, if the user wants to conduct digital payments at multiple service providers, then the user must set up an account at each service provider. This reduces user engagement and loyalty.

The present method allows the user to simply use the account at the system provider to conduct payments for services from multiple service providers. No need to create multiple user accounts and user profiles as the present management platform manages the digital payments to each service provider. The management platform splits the total amount into individual amounts equal to the services selected from each respective service provider. The individual amounts are then transferred via a secure payment module to each service provider. This further contributes to the flexibility and adaptability of the present system.

Each service provider may access the management platform via a dedicated user profile to edit, review and/or add information relating to a particular machine and the services thereof. For example, the service provider may create a machine identification, services available on that machine, pricings, information relating to its start signal, information relating to its busy signal, etc. Further, each service provider may access the management platform via their user profile to evaluate the performance of each machine and the income generated by the machines registered in the present system.

The user may simply use the graphical user interface of the application to select any machine from any service provider registered at that location. Likewise, the user may use the present system to conduct digital payments at different locations of different service providers. This further contributes to promote user engagement and loyalty.

According to one embodiment, the method further comprises the steps of:
selecting, using the application, another service of a further service provider,
initiating, by the application, a payment of the selected other service by transmitting transaction information to the management platform,
if the payment is completed, then transferring, by the management platform, an amount of payment equivalent to the selected other service from the user's account to that further service provider, and
transmitting, by the management platform, updated transaction information back to the application on the mobile device.

The present method also allows service providers of different types of services to sign up and register their services in the management platform. The service providers may have machines of different types that perform different services. The machines of different service providers may be installed at separate, dedicated locations. Alternatively, machines from multiple service providers may be installed at the same location. For example, laundromats may comprise machines from multiple service providers, e.g. different manufactures, where each machine may be registered in the management platform and can be selected via the application. For example, laundromats may comprise a number of laundry machines and a number of drinking or vending machines. This further contributes to the flexibility and adaptability of the present system.

The management platform may generate a list of all machines registered at a particular location, which may then be transmitted to the mobile device of a user. The user may then select any machine and service via the graphical user interfaces of the application, as mentioned above. This further contributes to promote user engagement and loyalty.

According to one embodiment, the user selects a subscription agreement, by a subscription module in the management platform, the subscription agreement is linked to the user's profile and used, by the application, when conducting exclusive payments for selected services of one or more service providers.

The present management platform may be adapted to incorporate multiple value-added features that enhances user engagement and profitability. These features may be adapted to also promote financial sustainability and operational efficiency.

For example, the management platform may be adapted to incorporate one or more subscriptions, each descriptive of a predetermined pricing model, which the user can choose between. The pricing model may be a fixed (e.g., a flat rate) or variable (e.g., user-based) depending on the desired pricing strategy. The pricing model may be selected based on the target market, type of services, customer behaviour and demands, etc. to provide an optimal balance between monetization, customer acquisition and retention. This promotes customer loyalty and provides a predictable revenue stream for the service provider.

The selected subscription may be linked to the user's profile and used when determining, by a subscription module, the price of the selected services of that service provider. The adjusted pricing determined by the subscription module may be transmitted to the mobile device and displayed in the graphical user interface during the payment process.

According to one embodiment, the user earns loyalty rewards, by a loyalty module in the management platform, based on the user's selections, accumulated payments and/or user activities within a time period registered by the management platform, wherein the loyalty rewards are added to the user's profile and/or user account.

For example, the management platform may be adapted to incorporate one or more royalty models, each descriptive of conditions or milestones for achieving a loyalty reward. The royalty model may be selected based on historical or estimated customer behaviour, interactions with the machines of that service provider, cumulative spendings, and the like. The loyalty model may be descriptive of discounts or loyalty points for achieving a reduced pricing for services. This also promotes customer loyalty and provides a predictable revenue stream for the service provider.

The loyalty rewards may be determined by a loyalty module and the loyalty rewards may be stored together with the user profile. The loyalty rewards may be used when determining the total amount for selected services of that service provider. The adjusted pricing determined by the loyalty module may be transmitted to the mobile device and displayed in the graphical user interface during the payment process.

According to one embodiment, the user further earns loyalty rewards, by the loyalty module in the management platform, by interacting with one or more games within the application on the mobile device and/or by new users creating a user profile in the management platform based on a referral from the user.

Further, the application may be adapted to incorporate one or more games, e.g. provided by the system provider, service provider or a third-party provider, in which the user may earn loyalty rewards or loyalty points. This further promotes customer engagement and profitability, and in turn increase revenues for the service provider.

Also, when creating new users in the management platform, the new user may indicate if a referral from another user was used. A signal may then be transmitted to the loyalty module, which may then add a loyalty reward to the user indicated in the referral. This further promotes customer engagement and profitability, and in turn increase revenues for the service provider.

In one embodiment, one or more service providers provides one or more fundings of costs, where the user transfers payment, by a funding module in the management platform, to at least one funding account in the management platform, wherein the user payments are then transferred from the management platform to the service provider.

The service provider may, via their user profile, set up one or more funding accounts and information associated with the fundings, e.g. shares of the profit. Users may then transfer payments to this funding account via a funding module in the management platform. This allows the service provider to collect fundings for investment in new machines and/or new locations. The service provider may also collect fundings for operational costs of maintaining locations and machines thereof. The fundings may also be arranged so that users may sponsor the costs for new machines and/or the operational costs for selected machines. This promotes user profitability and user engagement as the users may gain a financial incentive to remain loyal to that service provider.

According to one embodiment, the payment is conducted using blockchains or cryptocurrency, by a network of computers, and/or the amount of payment transferred to the service provider is split into two or more instalments or is conducted at a later payment date, by the payment module.

Payment may be conducted using conventional digital payments, e.g. credit cards and bank accounts, using a trusted third party (e.g. a payment processing company (credit card company)) or a centralised payment system (e.g. a centralised bank database).

However, the present system also allows payments to be conducted using blockchain based payment or cryptocurrency. The blockchain based payment (e.g. Bitcoin or Altcoin) may be conducted using a decentralised payment system, (e.g. a peer-to-peer network of computers). Here, the term “cryptocurrency” is broadly defined as virtual or digital money that takes the form of “tokens” or “coins” and uses a decentralised network and cryptography to secure the transactions.

This allows the user to buy services immediately and pay later. The service provider may generate revenue through merchant fees or interest charges.

According to one embodiment, the management platform communicates with a gig management platform comprising a plurality of user profiles of gig workers registered in the gig management platform, wherein the gig workers access the management platform by the application on the mobile device.

The management platform may also communicate with a gig management platform, which may store the user profile of a plurality of gig workers. Here, the term “gig worker” is defined as a person that engages in freelance work or temporary, short-term contracts with companies. The gig user profile may be used as a user profile for accessing the present management platform, wherein each gig worker may download and install the application described above to interact with the present management platform.

This allows gig workers as well as users of the present system to conduct digital payments for services at different service providers.

According to one embodiment, the user interacts, by the application on the mobile device and/or by instore displays in a local business, with a promotion module in the management platform to further accumulate loyalty rewards in the royalty module.

In a special configuration, the user may interact with instore displays in local businesses to earn additional loyalty rewards. The instore displays may communicate with the management platform, e.g. via the application in the mobile device. The loyalty rewards may be stored together with the user's profile and may used when conducting payments for services.

Alternatively, the user may interact with a dedicated user graphical interface in the application to select and pay for services in local businesses, e.g. by scanning or entering a unique code. The local business may have signed a cross-promotion agreement between a particular service provider and that local business so that users of the present users is able to earn additional loyalty rewards. This further promotes user loyalty and engagement. Further, this allows the management platform to be adapted to communicate with further service providers or local businesses, which allows the present solution to be adapted to the digital lifestyle of customers.

The loyalty reward (e.g. discount) may be based on the geographic location of the user, hence the mobile device, during usage of the application. The location of the user may be compared to the geographic location of local businesses (e.g. stores or cafes) to determine if any special offers, e.g. discounts or coupons, are available within the proximity to the location of the user.

According to one embodiment, the payments are based on dynamic pricings and/or smart discounts of selected services from one or more service providers, wherein the dynamic pricings and/or smart discounts are determined, by the management platform, using artificial intelligence and/or a machine learning algorithm where historical user behaviour and/or operational costs are used as input for the artificial intelligence or machine learning algorithm.

The management platform may incorporate the use of artificial intelligence and/or machine learning algorithms to determine the pricings of services from one or more service providers. This allows smart pricing or dynamic pricings to be used when determining the total pricing for the selected services. The models for these smart pricing or dynamic pricings may be selected to calculate the optimal costs for services while maximising the profit. Such smart pricing technologies are known to the skilled person.

One object of the present invention is also achieved by a system, according to claim 12, for conducting a cashless transaction for purchase of at least one commercial service by a user from a machine, the system comprising:
at least one machine configured to perform at least one service, wherein the at least one machine comprises input means for activation of that machine,
a mobile device of the user, having at least a processor, a memory, a display and a communications module,
a downloadable application that is installed on the mobile device, wherein the application comprises executable instructions for generating and displaying at least one graphic user interface on the mobile device, and for registering the user's interaction with the application,
a management platform of a system provider that is implemented on a server with a processor, a memory, and a communications module for communicating with the communications module of the mobile device, wherein the management platform comprises a secure payment module for conducting payments and for transferring of payments to a secure payment module of a service provider, wherein the memory comprises at least a user profile and a user account associated with the user,
wherein the application further comprises executable instructions for
   selecting a machine of a service provider and further selecting a service of the selected machine,
   transmitting transaction information to the management platform, and
wherein the management platform comprises executable instructions for
   completing the payment via the secure payment module,
   if the payment is completed, then transferring an amount of payment equivalent to the selected service from the user's account to the service provider of the selected machine, and further transmitting updated transaction information back to the application on the mobile device.

This provides an improved digital payment solution for services, which is flexible and scalable to adapt to the digital lifestyle of customers. The present system may users to create a user account at the system provider, not directly at the service provider, which can then be used to conduct payments with different service providers. The system provider manages the individual transactions to and from the respective service providers. This simplifies the transaction process and allows customers as well as service providers to gain an easier overview of all the transactions conducted via the present system.

The management platform may be implemented on a centralized server or a network of computers (cloud-based solution), comprising at least one processor and at least one memory. The computer program of the management platform and the application may be stored in the memory while the processor may be configured to execute the stored computer program.

The application can be downloaded and implemented on any mobile device comprising a display, a processor, a memory and communications means. The computer program of the application is stored in the memory and the processor is configured to execute this computer program.

This allows the management platform to be adapted and updated in a simple manner using an administrator user profile. Any updates to the application may be pushed directly to the mobile devices or be downloaded from an application platform, e.g. Google store or App Store.

According to one embodiment, the management platform further comprises a subscription module, wherein the subscription module comprises information of at least one subscription agreement with one or more service providers about exclusive pricings or discounts for selected services.

A subscription module may be implemented in the management platform, which comprises information of the pricing models for one or more subscriptions. The parameters for the pricing model may be stored in this subscription module and be used during the payment process to adjust the total pricing for the selected services. Information of the selected services and the service providers thereof may be inputted to this subscription module, which may then output the adjusted pricings for the selected services.

According to one embodiment, the management platform further comprises a loyalty module, wherein the loyalty module comprises information of parameters which triggers one or more loyalty rewards, e.g. loyalty tiers, wherein the parameters for the loyalty rewards are based on
the user's selections, accumulated payments and/or user activities within a time period,
the user's interaction with one or more games implemented within the application,
a number of new users creating a user profile in the management platform based on referral from the user, and/or
the user's interaction with a promotion module in the management platform or an instore display in a local business.

A loyalty module may be further implemented in the management platform, which comprises information of the milestones or conditions for achieving one or more loyalty rewards. Information of the earned loyalty wards may be stored together with the user's profile. Optionally, information of the selected services and the service providers thereof may be inputted to this loyalty module, which may then output the adjusted pricings for the selected services.

The loyalty rewards may be determined based on fixed or dynamic parameters. For example, this may be preferred when establishing loyalty rewards to individuals or members of a community.

The loyalty rewards may also be determined based on gamification or promotion features. For example, this may be preferred when establishing loyalty rewards based on the geographical location of the user.

The loyalty rewards may also be determined based on historical or real-time user behaviour. For example, this may be preferred when establishing loyalty rewards to customers that selects services during off-peak time periods.

The loyalty rewards may also be determined based on the user's interaction with one or more machines, the number of activations, etc.

The abovementioned examples may use individually or in combination to promote user loyalty and user engagement. This may in turn increase the revenue of the service providers and reduce operational costs.

According to one embodiment, the management platform further comprises a funding module, wherein the funding module comprises information of one or more funding accounts with one or more service providers, and where payments from the user are transferred, by the secure payment module, to the selected funding account and further to that service provider.

A funding module may further be implemented in the management platform, which may receive information from the service provider about a funding account and any profit paid back to the customer. The users may then use a dedicated graphical user interface in the application to conduct payments via a secure payment module to this funding account. The management platform may then transfer the accumulated fundings to the service provider via a secure payment module in the management platform. The secure payment module may also be used to transfer profits back to the user's account from the service provider in accordance with the funding agreement.

According to one embodiment, the management platform is configured to further communicate with a gig management platform via the communications module, the gig management platform comprising a plurality of user profiles of gig workers registered in the gig management platform, where gig workers are able to access the management platform by the application on the mobile device.

As mentioned earlier, the management platform may communicate with a gig management platform, where the registered gig workers may access the present management platform by downloading and executing the application on their mobile devices. This increases the flexibility of the present system and further promotes user loyalty.

Furthermore, the management platform may comprise a promotion module, which comprises information of one or more promotion campaigns or coupons issued by the system provider or a service provider. Parameters for activating the campaign or coupon may be stored in this promotion module. Optionally, information of the selected services and the service providers thereof may be inputted to this promotion module, which may then output the adjusted pricings for the selected services.

According to one embodiment, the machine is a laundry washer or dryer, which is configured to perform at least one laundry related service.

The present system are particularly suited for implementation in the laundromat industry, however the present system may also be used in other industries where a digital payment solution is desired.

### BRIEF DESCRIPTION OF THE FIGURES

FIG. 1 shows a prior art payment system for commercial services,

FIG. 2 shows an embodiment of the digital payment system according to the present invention,

FIG. 3 shows a first exemplary configuration of the system,

FIG. 4 shows a second exemplary configuration of the system,

FIG. 5 shows an exemplary configuration of the application, and

FIG. 6 shows an exemplary configuration of the management platform.

The present invention will now be described in more detail in the following.

### DETAILED DESCRIPTION OF THE INVENTION

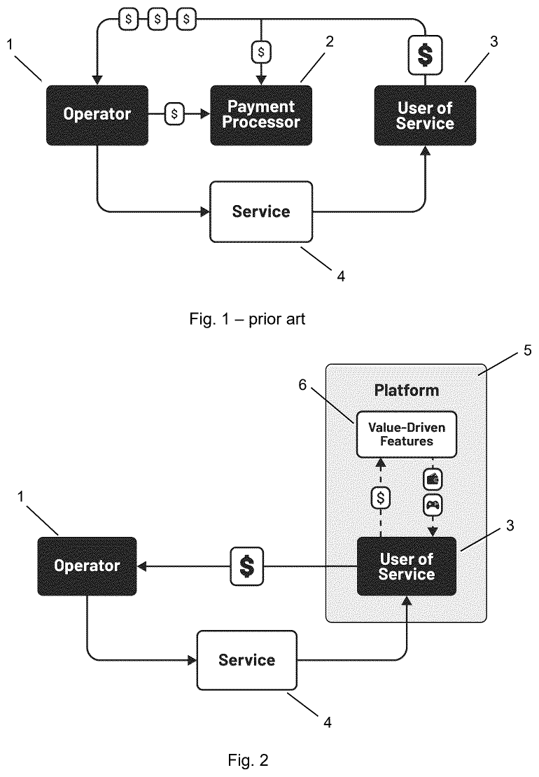

FIG. 1 shows a prior art payment system for digital payments of commercial services, such as laundromat services.

The service provider 1 (operator) has at least one location where one or more machines (not shown) are installed. The machines are configured to perform at least one service 4, such as a laundromat related service. The service provider 1 has a digital payment solution 2 (Payment Processor) comprising at least a processor and a memory. A computer program for digital payments of the selected services 4 is stored in the memory and executed by the processor. Users 3 of the services 4 has a dedicated user profile and user account at the service provider 1.

The users 3 conducts payments directly to the service provider 1 using the digital payment solution 2. A transaction fee is paid from the users 3 to the provider of the digital payment solution for each transaction. Furthermore, an annuity fee is paid from the service provider 1 to the provider of the digital payment solution in order to maintain the digital payment solution.

FIG. 2 shows an embodiment of the digital payment system according to the present invention.

Here, the users 3 have created dedicated user profiles and user accounts at a system provider, which manages the digital payment process on behalf of the service provider 1. The system provider has a management platform 5 implemented on a central server or network of computers. The user 3 downloads an application (not shown) onto their mobile device, which is configured to communicate with the management platform 5.

The user 3 executes the application on the mobile device and selects at least one machine and at least one service 4 from the service provider 1. The user 3 initiates and confirms payment to the system provider via the application. The system provider conducts payments from the user's account equivalent to the total amount of the selected services 4. The system provider then performs a transaction to the service provider 1 equal to the amount of selected services from that service provider 1.

The management platform 5 comprises a plurality of modules 6 configured to provide a plurality of value-driven features to the user. These value-driven features are configured to promote user loyalty and user engagement while introducing new revenue streams to the service provider 1.

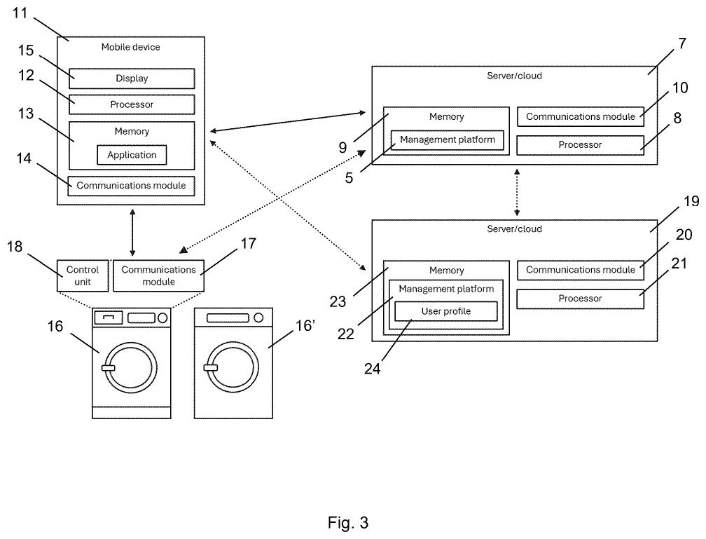

FIG. 3 shows a first exemplary configuration of the system. Here, the system is implemented in a laundromat, but the system may also be used in other industries.

The system comprises a server or a cloud-based network of computers 7, which comprises a least a memory 9 and a processor 8. The computer program of the management platform 5 is stored in the memory 9. The stored computer program is executed by the processor 8. The management platform 5 is configured to communicate with a mobile device 11 of a user via a communications module 10, e.g. a long-range or mobile network module.

The mobile device 11 comprises at least a corresponding communications module 14 for communicating with the management platform 5. The mobile device 11 has a memory 13, a processor 12 and a display 15. An application is downloaded and stored in the memory 13, where the processor 12 is configured to execute the computer program of the application. The user may interact with dedicated graphical user interfaces (GUIs) of the application via the display 15 or buttons on the mobile device 11.

A plurality of machines 16, 16′ are installed at the location of the service provider 1, wherein each machine 16 comprises a control unit 18 and a communications module 17. The control unit 18 is configured to control the operation of the machine 16, 16′. The mobile device 11 and/or the management platform 5 is able to communicate with the machine via a communications module 17 arranged on the machine 16, 16′.

The service provider 1 uses a dedicated user profile to access the management platform 5 to create a machine profile for each machine 16, 16′. The machine profile comprises at least a machine identification, a list of available services on that machine 16, 16′, a start signal for activating the machine 6, 16′ and a busy signal.

The user executes the application and interacts with GUIs of the application to select a machine 16. 16′ and a service of that machine 16, 16′. After completion of the selection, the user initiates the payment process using a GUI of the application. Information of the selected services are transmitted to the management platform 5, which determines the total amount for the selected services, as described later. A start signal is optionally transmitted from the mobile device 11 or the management platform 5 to the selected machine 16, 16′.

The user confirms the payment for the selected services by interacting with the GUI of the application. The management platform 5 then conducts payment from the user's account and transfers an amount equal to the selected services to the service provider 1. Optionally, a confirmation of the completed transaction is sent back to the mobile device 11 and displayed to the user.

Optionally, a confirmation signal is sent to the machine 16, 16′, which then start the machine 16, 16′ in accordance with the selected service.

Here, the management platform 5 is configured to further communicate with a gig management platform 22 via another communications module 20. The gig management platform 22 is implemented on another server or cloud-based network of computers 19. The computer program of this gig management platform 22 is stored in a memory 23 and a processor 21 is configured to execute the computer program.

A plurality of dedicated user profiles 24 of the gig workers are stored in the gig management platform 22. The gig workers is able to access the management platform 5 by the downloading and executing the application on their mobile device 11.

In another configuration of the present system, the gig management platform 22 may be omitted.

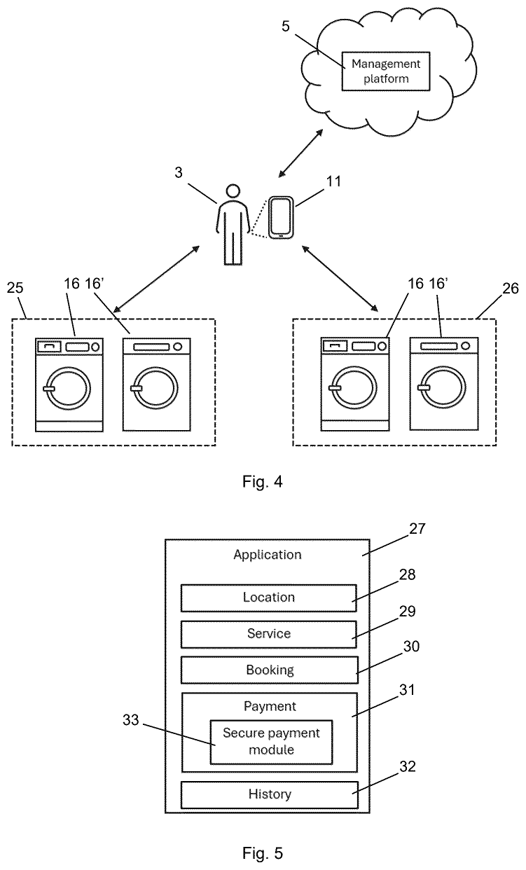

FIG. 4 shows a second exemplary configuration of the system. Different service providers with machines 16, 16′ installed at different locations 25, 26 are registered in the management platform 5 of the system provider.

The user 3 may enter one location 25 and select a machine 16, 16′ and a service thereof using the application on the mobile device 11. Payment for the selected service is performed as described in relation to FIG. 3.

The user 3 may then enter another location 26 and select a machine 16, 16′ and a service thereof using the same application on the mobile device 11. Payment for the selected service is performed as described in relation to FIG. 3.

The user's account in the management platform 5 can thus be used to conduct payments for services of different service providers, regardless of the machines 16, 16′ being installed at the same location or at different locations 25, 26. In other known digital payment solutions, the user profile and account is set up directly at the service provider. Thus, payments are limited to services provided by that service provider.

FIG. 5 shows an exemplary configuration of the application described in FIGS. 3 and 4. The application 27 is executed on the mobile device 11 and comprises a plurality of GUIS enabling the user 3 to interact with the application 27.

The user 3 uses a dedicated GUI 28 for determining the location of the machines 16, 16′ and optionally the location of the mobile device 11.

The user 3 is then directed to another dedicated GUI 29 for selecting a service of the selected machine 16, 16′.

The user 3 initiates the payment process using yet another dedicated GUI 31 in the application 27. Information of the selected services and the service providers thereof is transmitted to the management platform 5. The management platform 5 then determines the total amount of the selected services taken into account to the various value-driven features 6. Optionally, this total amount or adjusted total amount is then transmitted back to the mobile device 11 and displayed to the user 3.

The user 3 confirms the payment by further interacting with the GUI 31, after which the management platform 5 conducts payment for the user's account. A secure payment module 33 may be used by the user 3 to add funds to the user account.

Finally, the user 3 can access a dedicated GUI 32 to view information relating to all completed or attempted transactions between the user and the system provider.

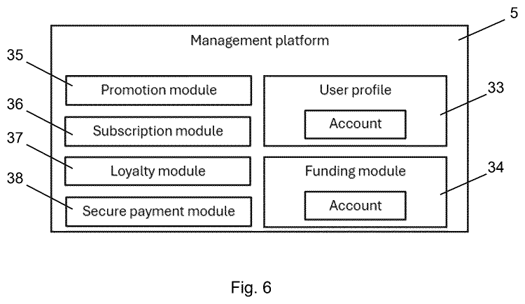

FIG. 6 shows an exemplary configuration of the management platform 5. The management platform 4 comprises a plurality of modules 34-37 for promoting user engagement and user loyalty.

Each user 3 has a user profile 33 and a user account stored in the memory 13. A promotion module 35 comprises information of campaigns and coupons, which the user can select and activate to earn loyalty rewards, e.g. discounts. A subscription module 36 comprises information of various subscriptions available to the user 3. Each subscription comprises information of a predetermined pricing model for services of a service provider 1. The selected subscription may be linked to the user profile 33. A loyalty module 37 comprises parameters for earning one or more loyalty rewards. The loyalty rewards earned by the user 3 is stored together with the user profile 33.

Each of the modules 35-37 may receive information of the selected services and the service providers 1 thereof. The respective modules 35-37 may then output an adjusted pricing for the selected services. Thus adjusted pricing is then transmitted to the payment GUI 31 in the application 27 and the secure payment module 28.

A funding module 34 may further be implemented in the management platform 4. The funding module 24 comprises information of a funding account for a service provider 1 and information of profits being paid back to the user 3. The user 3 conducts payment to this funding account using the secure payment module 33, and the management platform 5 transfers the funding amount to the service provider using the secure payment module 38. The funding module 34 and secure payment modules 33, 38 are used to transfer profits back to the user 3 in accordance with the funding agreement.

The present invention will now be described in more detail in the following.

What is claimed is:

1. A method of conducting a cashless transaction for purchase of at least one commercial service by a user from a machine, the user having a mobile device with at least a processor, a memory, a display and a communications module, wherein an application is installed on the mobile device, the method comprising:
executing the application on the mobile device, wherein user interacts with the application via at least one graphic user interface of the application,
selecting, using the application, at least one machine of at least one service provider and further selecting at least one service of the at least one machine, wherein machines of different service providers are registered in the management platform at a plurality of different locations, and the at least one machine is selected from a list of machines registered at a selected one of the different locations,
initiating, by the application, a payment of the selected service by transmitting transaction information directly to a management platform of a system provider, in which the user has created a user profile and a user account,
if the payment is completed, then transferring, by the management platform, an amount of payment equivalent to the selected service from the user's account to the service provider of that selected machine,
transmitting, by the management platform, updated transaction information directly back to the application on the mobile device, and
if the payment is completed, activating the selected machine in accordance with the selected service.

2. The method according to claim 1, further comprising:
selecting, using the application, another machine of another service provider and further selecting another service of the other machine,
initiating, by the application, a payment of the selected other service by transmitting transaction information directly to the management platform,
if the payment is completed, then transferring, by the management platform, an amount of payment equivalent to the selected other service from the user's account to the other service provider of the other machine,
transmitting, by the management platform, updated transaction information directly back to the application on the mobile device, and
if the payment is completed, optionally activating the other machine in accordance with the selected other service.

3. The method according to claim 1, further comprising:
selecting, using the application, a further service of a further service provider,
initiating, by the application, a payment of the selected further service by transmitting transaction information directly to the management platform,
if the payment is completed, then transferring, by the management platform, an amount of payment equivalent to the selected further service from the user's account to that further service provider, and
transmitting, by the management platform, updated transaction information directly back to the application on the mobile device.

4. The method according to claim 1, wherein when the user selects a subscription agreement, by a subscription module in the management platform, the subscription agreement is linked to the user's profile and used, by the application, when conducting exclusive payments for selected services of one or more service providers.

5. The method according to claim 1, wherein the user earns loyalty rewards, by a loyalty module in the management platform, based on the user's selections, accumulated payments and/or user activities within a time period registered by the management platform, wherein the loyalty rewards are added to the user's profile and/or user account.

6. The method according to claim 5, wherein the user further earns loyalty rewards, by the loyalty module in the management platform, by interacting with one or more games within the application on the mobile device and/or by new users creating a user profile in the management platform based on a referral from the user.

7. The method according to claim 1, wherein one or more service providers provides one or more fundings of costs, where the user transfers payment, by a funding module in the management platform, to at least one funding account in the management platform, wherein the user payments are then transferred from the management platform to the service provider.

8. The method according to claim 1, wherein the payment is conducted using blockchains or cryptocurrency, by a network of computers, and/or the amount of payment transferred to the service provider is split into two or more instalments or is conducted at a later payment date, by the payment module.

9. The method according to claim 1, wherein the management platform communicates with a gig management platform comprising a plurality of user profiles of gig workers registered in the gig management platform, wherein the gig workers access the management platform by the application on the mobile device.

10. The method according to claim 1, wherein the user interacts, by the application on the mobile device and/or by instore displays in a local business, with a promotion module in the management platform to further accumulate loyalty rewards in a loyalty module.

11. The method according to claim 4, wherein the payments are based on dynamic pricings and/or smart discounts of selected services from one or more service providers, wherein the dynamic pricings and/or smart discounts are determined, by the management platform, using artificial intelligence and/or a machine learning algorithm where historical user behavior and/or operational costs are used as input for the artificial intelligence or machine learning algorithm.

12. A system for conducting a cashless transaction for purchase of at least one commercial service by a user from a machine, the system comprising:
at least one machine configured to perform at least one service, wherein the at least one machine comprises input means for activation of that machine,
a mobile device of the user, having at least a processor, a memory, a display and a communications module,
a downloadable application that is installed on the mobile device, wherein the application comprises executable instructions for generating and displaying at least one graphic user interface on the mobile device, and for registering the user's interaction with the application,
a management platform of a system provider that is implemented on a server with a processor, a memory, and a communications module for communicating with the communications module of the mobile device, wherein the management platform comprises a secure payment module for conducting payments and for transferring of payments to a secure payment module of a service provider, wherein the memory comprises at least a user profile and a user account associated with the user,
wherein the application further comprises executable instructions for
selecting a machine of a service provider and further selecting a service of the selected machine, wherein machines of different service providers are registered in the management platform at a plurality of different locations, and the at least one machine is selected from a list of machines registered at a selected one of the different locations,
transmitting transaction information directly to the management platform, and
wherein the management platform comprises executable instructions for completing the payment via the secure payment module,
if the payment is completed, then transferring an amount of payment equivalent to the selected service from the user's account to the service provider of the selected machine, and further transmitting updated transaction information directly back to the application on the mobile device.

13. The system according to claim 12, wherein the management platform further comprises a subscription module, wherein the subscription module comprises information of at least one subscription agreement with one or more service providers about exclusive pricings or discounts for selected services.

14. The system according to claim 12, wherein the management platform further comprises a loyalty module, wherein the loyalty module comprises information of parameters which triggers one or more loyalty rewards, e.g. loyalty tiers, wherein the parameters for the loyalty rewards are based on
the user's selections, accumulated payments and/or user activities within a time period,
the user's interaction with one or more games implemented within the application,
a number of new users creating a user profile in the management platform based on referral from the user, and/or
the user's interaction with a promotion module in the management platform or an instore display in a local business.

15. The system according to claim 12, wherein the management platform further comprises a funding module, wherein the funding module comprises information of one or more funding accounts with one or more service providers, and where payments from the user are transferred, by the secure payment module, to the selected funding account and further to that service provider.

16. The system according to claim 12, wherein the management platform is configured to further communicate with a gig management platform via the communications module, the gig management platform comprising a plurality of user profiles of gig workers registered in the gig management platform, where gig workers are able to access the management platform by the application on the mobile device.

17. The system according to claim 12, wherein the machine is a laundry washer or dryer, which is configured to perform at least one laundry related service.

18. The method according to claim 1, wherein the list of machines registered at a selected one of the different locations is transmitted to the mobile device from the management platform, wherein the location is determined based on the geographic location of the mobile device.

19. The method according to claim 18, wherein the list comprises machines of different types configured to perform different services.
